(19) United States
(12) Patent Application Publication
(10) Pub. No.: US 2024/0059872 A1
(43) Pub. Date: Feb. 22, 2024

(54) CORE-SHELL GRAPHENE-CONTAINING MICROCAPSULES AND METHOD OF MAKING

(71) Applicant: Technology Innovation Institute -Sole Proprietorship LLC, Masdar City (AE)

(72) Inventors: Natasa Tomic, Masdar City (AE); Abdullah Mustapha, Masdar City (AE); Maitha Al Mheiri, Masdar City (AE); Sachin Joshi, Masdar City (AE); Nujood AlShehhi, Masdar City (AE)

(73) Assignee: Technology Innovation Institute - Sole Proprietorship LLC, Masdar City (AE)

(21) Appl. No.: 18/451,479

(22) Filed: Aug. 17, 2023

Related U.S. Application Data
(60) Provisional application No. 63/398,627, filed on Aug. 17, 2022.

(51) Int. Cl. C08K 9/10; B01J 13/18; C09D 7/40; C09D 7/62; C09D 163/00; C01B 32/194

(52) U.S. Cl. CPC C08K 9/10; B01J 13/18; C09D 7/70; C09D 7/62; C09D 163/00; C01B 32/194

(57) ABSTRACT

The present disclosure provides methods of forming graphene-containing microcapsules, which may include steps of providing a graphene-containing precursor, combining the graphene-containing precursor with a drying oil such that the drying oil is intercalated within the graphene-containing precursor to form a graphene-containing aggregate, adding the graphene-containing aggregate to an aqueous solution comprising an emulsifier, and adding an encapsulating agent to form graphene-containing microcapsules. The graphene-containing microcapsules of the present disclosure may be used in numerous applications including in self-healing materials.

### CROSS-REFERENCE TO RELATED APPLICATIONS

This application claims priority to U.S. Provisional Patent Application No. 63/398,627, which was filed on Aug. 17, 2022, and is hereby incorporated by reference in its entirety.

### FIELD

The present disclosure relates generally to core-shell microcapsules which contain graphene, and methods of making and using the same. More specifically, the present disclosure relates to core-shell graphene-containing microcapsules for self-healing and corrosion prevention applications, along with a scalable and facile synthetic route for making said microcapsules.

### BACKGROUND

Microcracks and corrosion damage pose serious risks to mechanical and electrical systems. While the onset is difficult to detect, damage may compound until it reaches a point where significant time, cost, and resources must be dedicated to repairs. In some cases, the root cause of damage may be challenging to identify and there may also be safety concerns associated with repairing damaged parts, such as in marine applications.

Self-healing (SH) materials offer a solution in the form of active protection, wherein damage may be repaired before it progresses. SH materials are those that are capable of repairing or healing themselves when damaged by chemical, thermal, or mechanical forces. Typically formed from polymers, self-healing materials have widespread applicability in electronics, automotive, aerospace, and marine industries, wherein damage to parts can lead to system failure and significant repairs costs.

Self-healing materials may include a material that reacts upon temperature changes, or may include a material encapsulated within a shell, which, when broken, allows the material inside to react due to exposure to oxygen. In this way, whenever a structure or part that includes a self-healing material undergoes microdamage in the form of cracks or corrosion, the self-healing material repairs and prevents the damage from progressing.

By developing self-healing materials that include varied components and offer improved properties, the applicability of self-healing materials may expand, and a broader range of systems may be served.

### SUMMARY

There is provided a method for preparing microcapsules, which may include steps of providing a graphene-containing precursor, combining the graphene-containing precursor with a drying oil such that the drying oil is intercalated within the graphene-containing precursor to form a graphene-containing aggregate; adding the graphene-containing aggregate to an aqueous solution comprising an emulsifier, and adding an encapsulating agent to form graphene-containing microcapsules.

In some embodiments, the graphene-containing precursor includes graphene nanoplatelets (GNP). In some embodiments, the drying oil includes tung oil, linseed oil, perilla oil, walnut oil, or combinations thereof. In some embodiments, combining the graphene-containing precursor with the drying oil includes ultrasonic processing, according to any of the above embodiments.

In some embodiments, the aqueous solution according to any of the above embodiments includes about 0.1 wt. % to about 5 wt. % of the emulsifier. In some embodiments, the aqueous solution according to any of the above embodiments further includes at least one of about 0.5 wt. % to about 3 wt. % urea or melamine, about 0.05 wt. % to about 0.5 wt. % resorcinol, and about 0.05 wt. % to about 0.5 wt. % ammonium chloride. In some embodiments, the emulsifier according to any of the above embodiments includes gelatin, tween 80, poly(ethylene-alt-maleic anhydride), or combinations thereof. In some embodiments, the encapsulating agent according to any of the above embodiments includes formaldehyde. In some embodiments, about 1 wt. % to about 5 wt. % of the encapsulating agent is added, according to any of the above embodiments.

There are provided core-shell microcapsules, which may include a graphene-containing precursor and a drying oil encapsulated within a shell material. In some embodiments, the drying oil is intercalated into the graphene-containing precursor. In some embodiments, the shell material according to any of the above embodiments includes urea-formaldehyde, melamine-formaldehyde, or combinations thereof.

In some embodiments, the core-shell microcapsules according to any of the above embodiments have a mean diameter of about 0.5 μm to about 25 μm. In some embodiments, the shell material has a thickness of about 280 nm to about 360 nm as measured by scanning electron microscopy (SEM). In some embodiments, the core-shell microcapsules according to any of the above embodiments have an average surface roughness of about 120 nm to about 130 nm as measured by atomic force microscopy (AFM).

There is provided a self-healing material which includes the core-shell microcapsules including graphene of the present disclosure. In some embodiments, the self-healing material which includes the core-shell microcapsules including graphene according to any of the above embodiments has a healing capability greater than self-healing materials which do not include graphene.

There is provided a corrosion-resistant material which includes the core-shell microcapsules of the present disclosure, according to any of the above embodiments.

### BRIEF DESCRIPTION OF THE DRAWINGS

Aspects, features, benefits, and advantages of the embodiments described herein will be apparent with regard to the following description, appended claims, and accompanying drawings where:

FIG. 1 is a flow chart describing steps of a method to produce graphene-containing microcapsules, according to some embodiments of the present disclosure.

FIG. 2 is an illustrative depiction of a graphene-containing microcapsule, according to some embodiments of the present disclosure.

FIG. 3 is an optical microscopy image of graphene-containing microcapsules, according to some embodiments of the present disclosure.

FIG. 4A and FIG. 4B are graphs showing the relationship between contact angle of a solution of the drying oil and graphene nanoplatelets and the content of graphene nanoplatelets.

FIG. 5A, FIG. 5B, and FIG. 5C are gel permeation chromatography/refractive index (GPC-RI) chromatograms for pure tung oil microcapsules, microcapsules containing 1% graphene nanoplatelets, microcapsules containing 3% graphene nanoplatelets, and microcapsules containing 5% graphene nanoplatelets. FIG. 5A shows the baseline full spectrum. FIG. 5B is a zoomed-in image of Peak 1 from FIG. 5A. FIG. 5C is a zoomed-in image of Peak 2 from FIG. 5A.

FIG. 6A is a TEM image of pure tung oil microcapsules at 25,000× magnification, scale bar 600 nm. FIG. 6B is a TEM image of pure tung oil microcapsules at 60,000× magnification, scale bar 200 nm. FIG. 6C is a TEM image of pure tung oil microcapsules at 50,000× magnification, scale bar 200 nm.

FIG. 7A is a TEM image of microcapsules containing 1% graphene nanoplatelets at 20,000× magnification, scale bar 200 nm. FIG. 7B is a TEM image of microcapsules containing 1% graphene nanoplatelets at 75,000× magnification, scale bar 200 nm. FIG. 7C is a TEM image of microcapsules containing 1% graphene nanoplatelets at 30,000× magnification, scale bar 500 nm. FIG. 7D is a TEM image of microcapsules containing 1% graphene nanoplatelets at 150,000× magnification, scale bar 100 nm.

FIG. 8A is a TEM image of microcapsules containing 3% graphene nanoplatelets at 20,000× magnification, scale bar 800 nm. FIG. 8B is a TEM image of microcapsules containing 3% graphene nanoplatelets at 100,000× magnification, scale bar 100 nm. FIG. 8C is a TEM image of microcapsules containing 3% graphene nanoplatelets at 120,000× magnification, scale bar 100 nm.

FIG. 9A is a TEM image of microcapsules containing 5% graphene nanoplatelets at 6,000× magnification, scale bar 2 μm. FIG. 9B is a TEM image of microcapsules containing 5% graphene nanoplatelets at 75,000× magnification, scale bar 200 nm. FIG. 9C is a TEM image of microcapsules containing 5% graphene nanoplatelets at 100,000× magnification, scale bar 100 nm.

FIG. 9D is a TEM image of microcapsules containing 5% graphene nanoplatelets at 150,000× magnification, scale bar 100 nm.

FIG. 10A is a TEM image of microcapsules containing 5% graphene nanoplatelets at 25,000× magnification, scale bar 600 nm. FIG. 10B is a TEM image of microcapsules containing 5% graphene nanoplatelets at 100,000× magnification, scale bar 100 nm. FIG. 10C is a TEM image of microcapsules containing 5% graphene nanoplatelets at 120,000× magnification, scale bar 100 nm.

FIG. 11A is a TEM image of microcapsules containing 5% graphene nanoplatelets at 25,000× magnification, scale bar 600 nm. FIG. 11B is a TEM image of microcapsules containing 5% graphene nanoplatelets at 75,000× magnification, scale bar 200 nm.

FIGS. 12A-12E are optical microscopy images of steel substrates which were scratched with a scalpel. An epoxy coating was applied to evaluate healing capacity. FIG. 12A shows a coating of pure epoxy, FIG. 12B shows an epoxy coating with pure tung oil microcapsules, FIG. 12C shows an epoxy coating with microcapsules containing 1% graphene nanoplatelets, FIG. 12D shows an epoxy coating with microcapsules containing 3% graphene nanoplatelets, and FIG. 12E shows an epoxy coating with microcapsules containing 5% graphene nanoplatelets.

FIG. 13 is an image of steel substrates which were scratched with a scalpel followed by application of an epoxy coating. The epoxy coatings were, from left to right, pure epoxy, epoxy coating with pure tung oil microcapsules, epoxy coating with microcapsules containing 1% graphene nanoplatelets, epoxy coating with microcapsules containing 3% graphene nanoplatelets, and epoxy coating with microcapsules containing 5% graphene nanoplatelets, showing the healing capabilities of each coating.

### DETAILED DESCRIPTION

This disclosure is not limited to the particular systems, devices and methods described, as these may vary. The terminology used in the description is for the purpose of describing the particular versions or embodiments only and is not intended to limit the scope. The following terms may be used in the present disclosure.

As used herein, the term “drying oil” refers to an oil that hardens to a solid film after a period of exposure to air via crosslinking.

As used herein, the term “self-healing” refers to materials that are capable of automatically repairing damage sustained by physical, chemical, or thermal forces.

As used herein, the term “self-sensing” refers to the ability to detect micro- or nanoscale damage in a material by observing a change in one of its properties, such as color, electrical properties, and other indicators.

As used herein, the term “graphene nanoplatelets” refers to a plurality of layers of graphene with a thickness of about 3 nm to about 100 nm.

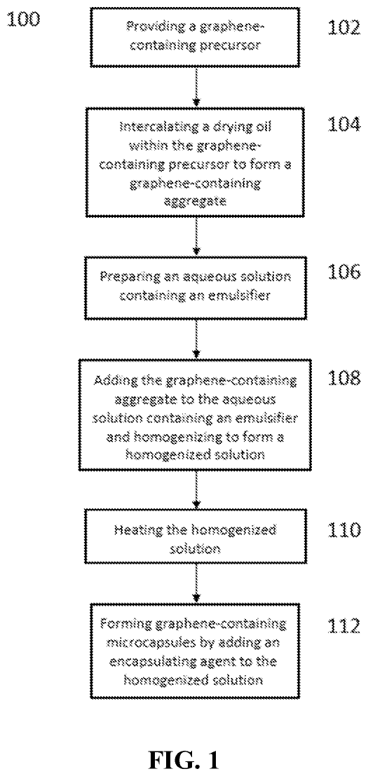

There is a provided a method of producing microcapsules, according to some embodiments of the present disclosure. FIG. 1 is a flow chart describing steps of a method to produce graphene-containing microcapsules, according to some embodiments of the present disclosure. The method 100 may include a step of providing 102 a graphene-containing precursor, which may include graphene nanoplatelets. Graphene is chemically inert and impervious to corrosive agents such as oxygen, corrosive ions, and water, and as such microcapsules that include graphene show an improvement in performance in self-healing and corrosion resistant materials over microcapsules that do not include graphene. There may be included about 0.1 wt. % to about 6 wt. % of the graphene-containing precursor, for example about 0.1 wt. %, about 0.5 wt. %, about 1 wt. %, about 1.5 wt. %, about 2 wt. %, about 2.5 wt. %, about 3 wt. %, about 3.5 wt. %, about 4 wt. %, about 4.5 wt. %, about 5 wt. %, about 5.5 wt. %, about 6 wt. %, or any range formed from any combination of the foregoing values.

The method may include a step of intercalating 104 a drying oil within the graphene-containing precursor, by combining the graphene-containing precursor with the drying oil, to form a graphene-containing aggregate. Combining the graphene-containing precursor with the drying oil may include using an ultrasonic processor. In some embodiments, the drying oil is intercalated within the layers of the graphene-containing precursor such that the inter-layer spacing between the layers of the graphene-containing precursor is increased. In some embodiments, the drying oil is arranged between a plurality of sheets of graphene, such that the inter-layer spacing distance is increased by up to about 0.3 nm relative to an unaltered graphene-containing precursor. For example, in some embodiments, the inter-layer spacing distance between layers of graphene may be increased by about 0.05 nm, about 0.10 nm, about 0.15 nm, about 0.20 nm, about 0.25 nm, about 0.30 nm, or any range formed from any combination of the foregoing values. In some embodiments, the ultrasonic processor used to combine the graphene-containing precursor with the drying oil may have variable settings such that factors such as power, current, time, and others that may be adjusted to suit the needs of a user of said ultrasonic processor. In some embodiments, combining the graphene-containing precursor with the drying oil may utilize a power of about 250 W and a current of about 68 amps. Combining the graphene-containing precursor with the drying oil may be conducted for a time of about 1 minute to about 30 minutes, for example about 1 min, about 5 min, about 10 min, about 15 min, about 20 min, about 25 min, about 30 min, or any range formed from any combination of the foregoing values.

The method may include a step of preparing 106 an aqueous solution containing an emulsifier. The aqueous solution containing an emulsifier may be prepared according to some embodiments of the present disclosure. The emulsifier may include gelatin, polysorbate 80 (also known as tween 80), poly(ethylene-alt-maleic anhydride), or combinations thereof. It will be understood by those skilled in the art that other emulsifiers may also be acceptable for use in and within the scope of the present disclosure. The aqueous solution may be formed by suspending about 0.1 wt. % to about 5 wt. % emulsifier in deionized water. For example, the aqueous solution may include about 0.1 wt. %, about 0.5 wt. %, about 1.0 wt. %, about 1.5 wt. %, about 2.0 wt. %, about 2.5 wt. %, about 3.0 wt. %, about 3.5 wt. %, about 4.0 wt. %, about 4.5 wt. %, about 5.0 wt. % emulsifier, or any range formed from any combination of the foregoing values. The aqueous solution may further include about 0.5 wt. % to about 3.0 wt. % of urea or melamine, for example about 0.5 wt. %, about 1.0 wt. %, about 1.5 wt. %, about 2.0 wt. %, about 2.5 wt. %, about 3.0 wt. % urea or melamine, or any range formed from any combination of the foregoing values.

The aqueous solution may further include about 0.05 wt. % to about 0.50 wt. % resorcinol. For example, the aqueous solution may include about 0.05 wt. %, about 0.10 wt. %, about 0.15 wt. %, about 0.20 wt. %, about 0.25 wt. %, about 0.30 wt. %, about 0.35 wt. %, about 0.40 wt. %, about 0.45 wt. %, about 0.50 wt. % resorcinol, or any range formed from any combination of the foregoing values. The aqueous solution may further include about 0.05 wt. % to about 0.5 wt. % ammonium chloride. For example, the aqueous solution may further include about 0.05 wt. %, about 0.10 wt. %, about 0.15 wt. %, about 0.20 wt. %, about 0.25 wt. %, about 0.30 wt. %, about 0.35 wt. %, about 0.40 wt. %, about 0.45 wt. %, about 0.50 wt. % ammonium chloride, or any range formed from any combination of the foregoing values.

The aqueous solution may be stirred for a time of about 5 minutes to about 30 minutes, for example about 5 min, about 10 min, about 15 min, about 20 min, about 25 min, about 30 min, or any range formed from any combination of the foregoing values. The aqueous solution may also be stirred until the aqueous solution is completely clear, as opposed to stirring for a specific amount of time. After the aqueous solution has been stirred, the pH may be adjusted using a 1M solution of hydrochloric acid. The pH may be adjusted to about 3.0, about 3.5, about 4.0, or any range formed from any combination of the foregoing values.

The method may include a step of adding 108 the graphene-containing aggregate to the aqueous solution. The graphene-containing aggregate may be added to the aqueous solution in one portion or in multiple aliquots. The graphene-containing aggregate may be homogenized with the aqueous solution for a time of about 10 minutes to about 30 minutes, for example about 10 min, about 15 min, about 20 min, about 25 min, about 30 min, or any range formed from any combination of the foregoing values. The homogenization may include rotation or stirring at an angular velocity of about 5,000 rotations per minute (rpm) to about 20,000 rpm, for example about 5000 rpm, about 10,000 rpm, about 15,000 rpm, about 20,000 rpm, or any range formed from any combination of the foregoing values. Adding the graphene-containing aggregate to the aqueous solution and homogenizing forms a homogenized solution.

The method may include a step of heating 110 the homogenized solution, according to some embodiments of the present disclosure. The homogenized solution may be heated at a temperature of about 40° C. to about 90° C., for example about 40° C., about 45° C., about 50° C., about 55° C., about 60° C., about 65° C., about 70° C., about 75° C., about 80° C., about 85° C., about 90° C., or any range formed from any combination of the foregoing values.

The method may include a step of forming 112 graphene-containing microcapsules by adding an encapsulating agent to the homogenized solution. The encapsulating agent may include formaldehyde. According to some embodiments of the present disclosure, about 1 wt. % to about 5 wt. % of encapsulating agent may be added to the homogenized solution. For example, about 1 wt. %, about 2 wt. % about 3 wt. %, about 4 wt. %, about 5 wt. %, or any range formed from any combination of the foregoing values, of encapsulating agent may be added.

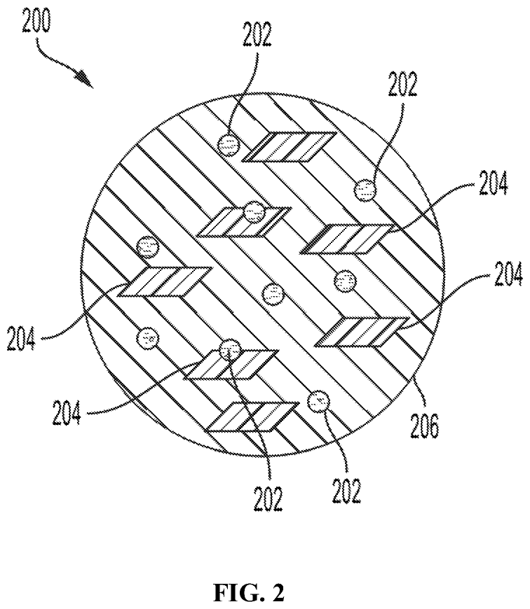

This disclosure also describes core-shell microcapsules which may be formed by methods described herein, wherein the core-shell microcapsules may include a drying oil and a graphene-containing precursor. FIG. 2 is an illustrative depiction of a graphene-containing microcapsule, according to some embodiments of the present disclosure.

The graphene-containing microcapsule 200 of the present disclosure may include a drying oil 202. The drying oil 202 may include tung oil, linseed oil, perilla oil, walnut oil, or combinations thereof. Drying oils are a class of liquid oils that may react with atmospheric oxygen, which acts as a catalyst for polymerization, such that the drying oil may cross-link and solidify. The unsaturated conjugated systems in the structure of drying oils are associated with their quick curing, or ability of polymer chains to rapidly cross-link. The degree of unsaturation determines the rate of curing, with a higher degree of unsaturation resulting in faster cross-linking relative to drying oils with lower degrees of unsaturation.

The graphene-containing microcapsule 200 may include a graphene-containing precursor 204 which may include graphene nanoplatelets. Graphene nanoplatelets may include a plurality of sheets of graphene, or layers of graphene, about 3 nm to about 100 nm thick and having an inter-layer spacing distance of 0.30 nm to about 0.37 nm. The graphene-containing precursor provides the microcapsules with improved corrosion resistance relative to microcapsules that do not contain graphene. The graphene-containing microcapsule 200 may include about 0.1 wt. % to about 6 wt. % graphene-containing precursor, for example about 0.1 wt. %, about 0.5 wt. %, about 1 wt. %, about 1.5 wt. %, about 2 wt. %, about 2.5 wt. %, about 3 wt. %, about 3.5 wt. %, about 4 wt. %, about 4.5 wt. %, about 5 wt. %, about 5.5 wt. %, about 6 wt. %, or any range formed from any combination of the foregoing values.

The graphene-containing precursor 204 may be combined with the drying oil 202 such that the drying oil is intercalated within the graphene-containing precursor. After the drying oil 202 is intercalated within the graphene-containing precursor 204, the inter-layer spacing distance between the plurality of sheets of graphene may be increased, such that the inter-layer spacing distance between the layers of graphene may be about 0.40 nm to about 0.60 nm. For example, in some embodiments the inter-layer spacing distance between the plurality of sheets of graphene intercalated with the drying oil may be about 0.40 nm, about 0.45 nm, about 0.50 nm, about 0.55 nm, about 0.60 nm, or any range formed from any combination of the foregoing values.

The graphene-containing microcapsule 200 may include a shell material 206. The shell material 206 may include urea-formaldehyde, melamine-formaldehyde, or combinations thereof. The shell material 206 prevents the drying oil 202 from cross-linking prematurely by forming a barrier from atmospheric oxygen. The shell material 206 may be formed by in-situ polymerization, a microencapsulation method in which a polycondensation reaction occurs to form a shell around a core material, wherein said polycondensation reaction is initiated by a change in pH and/or temperature. The shell material 206 may include an amino resin, which may be formed by the polycondensation of urea and formaldehyde, melamine and formaldehyde, or combinations thereof. Amino resins offer high chemical and mechanical stability, water resistance, and low permeability. The shell material 206 surrounds the graphene-containing precursor 204 and the drying oil 202. The shell material 206 may have a thickness of about 280 nm to about 360 nm. For example, the shell material 206 may have a thickness of about 280 nm, about 290 nm, about 300 nm, about 310 nm, about 320 nm, about 330 nm, about 340 nm, about 350 nm, about 360 nm, or any range formed from any combination of the foregoing values. The thickness of the shell material 206 may be measured by scanning electron microscopy (SEM) or other suitable method known to one skilled in the art.

The core-shell microcapsules of the present disclosure may have a mean diameter of about 0.5 μm to about 25 μm. For example, the mean diameter of the core-shell microcapsules may be about 0.5 μm, about 1 μm, about 2 μm, about 3 μm, about 4 μm, about 5 μm, about 6 μm, about 7 μm, about 8 μm, about 9 μm, about 10 μm, about 11 μm, about 12 μm, about 13 μm, about 14 μm, about 15 μm, about 16 μm, about 17 μm, about 18 μm, about 19 μm, about 20 μm, or any range formed from any combination of the foregoing values.

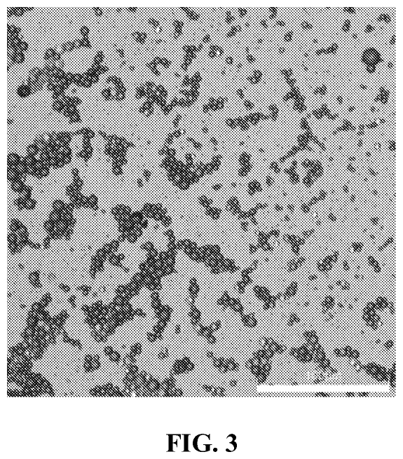

In some embodiments, the core-shell microcapsules of the present disclosure which include graphene may have a higher surface roughness than microcapsules which do not include graphene. Higher surface roughness can contribute to better adhesion and improved performance, without wishing to be bound by theory. The microcapsules of the present disclosure may have a surface roughness which can be quantified by atomic force microscopy (AFM). FIG. 3 is an optical microscopy image of graphene-containing microcapsules. The surface roughness of the microcapsules of the present disclosure may be about 120 nm to about 130 nm, for example about 120 nm, about 121 nm, about 122 nm, about 123 nm, about 124 nm, about 125 nm, about 126 nm, about 127 nm, about 128 nm, about 129 nm, about 130 nm, or any range formed from any combination of the foregoing values. The root mean square (RMS) roughness of the microcapsules of the present disclosure may be about 21.5 nm.

There is provided a method for preparing microcapsules, which may include steps of providing a graphene-containing precursor, combining the graphene-containing precursor with a drying oil such that the drying oil is intercalated within the graphene-containing precursor to form a graphene-containing aggregate; adding the graphene-containing aggregate to an aqueous solution comprising an emulsifier, and adding an encapsulating agent to form graphene-containing microcapsules.

In some embodiments, the graphene-containing precursor includes graphene nanoplatelets. In some embodiments, the drying oil according to any of the preceding embodiments includes tung oil, linseed oil, perilla oil, walnut oil, or combinations thereof. In some embodiments, combining the graphene-containing precursor with the drying oil includes ultrasonic processing, according to any of the preceding embodiments.

In some embodiments, the aqueous solution according to any of the preceding embodiments includes about 0.1 wt. % to about 5 wt. % of the emulsifier. In some embodiments, the aqueous solution according to any of the preceding embodiments further includes at least one of about 0.5 wt. % to about 3 wt. % urea or melamine, about 0.05 wt. % to about 0.5 wt. % resorcinol, and about 0.05 wt. % to about 0.5 wt. % ammonium chloride. In some embodiments, the emulsifier according to any of the preceding embodiments includes gelatin, tween 80, poly(ethylene-alt-maleic anhydride), or combinations thereof. In some embodiments, the encapsulating agent according to any of the preceding embodiments includes formaldehyde. In some embodiments, about 1 wt. % to about 5 wt. % of the encapsulating agent is added.

There are provided core-shell microcapsules, which may include a graphene-containing precursor and a drying oil encapsulated within a shell material. In some embodiments, the drying oil according to any of the preceding embodiments is intercalated into the graphene-containing precursor. In some embodiments, the shell material according to any of the preceding embodiments includes urea-formaldehyde, melamine-formaldehyde, or combinations thereof.

In some embodiments, the core-shell microcapsules according to any of the preceding embodiments have a mean diameter of about 0.5 μm to about 25 μm. In some embodiments, the shell material according to any of the preceding embodiments has a thickness of about 280 nm to about 360 nm. In some embodiments, the core-shell microcapsules according to any of the preceding embodiments have an average surface roughness of about 120 nm to about 130 nm as measured by atomic force microscopy (AFM).

There is provided a self-healing material which includes the core-shell microcapsules according to any of the preceding embodiments of the present disclosure. In some embodiments, the self-healing material according to any of the preceding embodiments has a healing capability greater than a self-healing material which does not include a graphene-containing precursor.

There is provided a corrosion-resistant material which includes the core-shell microcapsules according to any of the preceding embodiments of the present disclosure.

This disclosure describes core-shell microcapsules that may include a graphene-containing precursor and a drying oil. This disclosure further describes a method of producing microcapsules and methods of use the same.

### EXAMPLES

### Example 1

Core-sell graphene-containing microcapsules were prepared according to methods of the present disclosure. Graphene nanoplatelets were mixed with tung oil and combined in an ultrasonic processor at about 250 W and 68 amps for about 1 minute, allowing the tung oil to intercalate between the layers of graphene and forming a graphene-containing aggregate solution. Separately, emulsifier solutions were prepared by mixing 0.5 g of emulsifier with 150 g deionized water. To this solution, 2.5 g urea, 0.25 g resorcinol, and 0.25 g ammonium chloride were added, and the resulting solution was stirred at room temperature. The pH of the solution was adjusted to about 3.5 using 1M hydrochloric acid. The solution was placed in a homogenizer at 10,000 rpm and about 10 mL of the graphene-containing aggregate solution was added. The mixture was allowed to homogenize for about 20 minutes, and then was transferred to heating apparatus for heating for about 60° C. About 6.5 mL of formaldehyde was added to the heated solution for initiate the formation of microcapsules. The solution was heated for about 4 hours, then allowed to cool to room temperature. The microcapsules were separated using a separatory funnel and vacuum filtration, washing with room temperature deionized water. The washing was repeated four times, after which the microcapsules were allowed to dry in ambient conditions.

TABLE 1

| | | | | | Dᵥ | Dᵥ | Dᵥ |
|---|---|---|---|---|---|---|---|
| | | SSA, | Dₛ, | Dᵥ, | (10), | (50), | (90), |
| Sample | Uniformity | m²/kg | μm | μm | μm | μm | μm |
| Tung oil/gelatin | 1.1 | 1264.0 | 3.7 | 10.7 | 1.6 | 6.6 | 26.0 |
| Tung oil/1% | 0.8 | 1634.0 | 2.9 | 7.9 | 1.2 | 6.0 | 17.4 |
| GNP/gelatin | | | | | | | |
| Tung oil/3% | 0.9 | 1386.0 | 3.4 | 10.5 | 1.4 | 7.6 | 23.1 |
| GNP/gelatin | | | | | | | |
| Tung oil/5% | 2.1 | 1425.0 | 3.3 | 19.4 | 1.3 | 7.7 | 25.6 |
| GNP/gelatin | | | | | | | |
| Tung oil/tween | 0.5 | 826.2 | 5.7 | 11.6 | 2.8 | 10.6 | 21.6 |
| 80 | | | | | | | |
| Tung oil/1% | 0.8 | 902.4 | 5.2 | 13.5 | 2.2 | 10.7 | 28.8 |
| GNP/tween 80 | | | | | | | |
| Tung oil/3% | 1.0 | 1027.0 | 4.6 | 14.3 | 2.0 | 10.0 | 33.6 |
| GNP/tween 80 | | | | | | | |
| Tung oil/5% | 0.7 | 727.9 | 6.4 | 15.6 | 2.8 | 12.8 | 32.6 |
| GNP/tween 80 | | | | | | | |
| Tung oil/5% | 2.4 | 2421.0 | 1.9 | 12 | 0.82 | 4.3 | 23.9 |
| GNP/gelatin/ | | | | | | | |
| tween 80 | | | | | | | |

As shown in TABLE 1, varying the emulsifier and the content of graphene nanoplatelets in the microcapsules offers varying properties. The percentages of GNP refer to the weight percentage of graphene nanoplatelets included. Uniformity is a measure of the absolute deviation from the median in terms of size of the microcapsules. Specific surface area or SSA is a measure of the total area of the particles divided by the total weight. Dᵥ represents the volume weighted mean diameter and D s is the surface weighted mean diameter. Dᵥ (10/50/90) is a measure of the size of the particles at which 10%, 50%, and 90% of the sample lies, respectively.

To microencapsulate the TO-GNP samples, an oil-in-water emulsion was first produced. Conventionally, an oil-in-water emulsion is described as a thermodynamically unstable system made from two immiscible liquids (often water and oil) in which the oil is dispersed throughout the water. Through creaming, coalescence, flocculation, or Ostwald ripening, emulsions may eventually separate into two phases. To reduce the interfacial tension between the oil and the water phases, emulsifiers and/or surfactants can be utilized to stabilize the droplets. The two surfactants of choice utilized here include Tween 80 and gelatin, though these surfactants are non-limiting. The hydrophilic head of the Tween 80 molecule is directed toward the aqueous phase and the hydrophobic tail toward the oil phase in the Tween 80-stabilized emulsion, generating a film at the oil-water interface during emulsification. Gelatin is a natural occurring amphiphilic macromolecule that can serve as an emulsifier in oil-in-water emulsions due to their surface-active characteristics.

To explore oil droplets after homogenization in water, four emulsions were produced. This includes TO with Tween 80 emulsifier, TO with gelatin emulsifier, TO and 1 wt. % GNP with Tween 80 emulsifier, and TO and 1 wt. % GNP with gelatin emulsifier. It can was observed that the Tween 80 and gelatin produced droplets with distinctively different droplet sizes, with the gel samples conveying much smaller droplets. Oil emulsions with the two emulsifiers were then analyzed by a Mastersizer and the results were summarized in a TABLE 1. It can be noticed that gelatin provided oil droplets of smaller sizes, but Tween 80 contributed to the more uniform size distribution. The addition of GNP to the oil at first reduced the size but with 5 wt. % the size started increasing again due to possible aggregation of GNP, without wishing to be bound by theory. The reduction in size was attributed to the stabilizing effect of TO by the addition of GNP. Furthermore, the combination of both gelatin and Tween 80 was investigated for TO emulsion with 5 wt. % of GNP. This combination of emulsifiers was observed to result in further reduction in size, but with reduced uniformity.

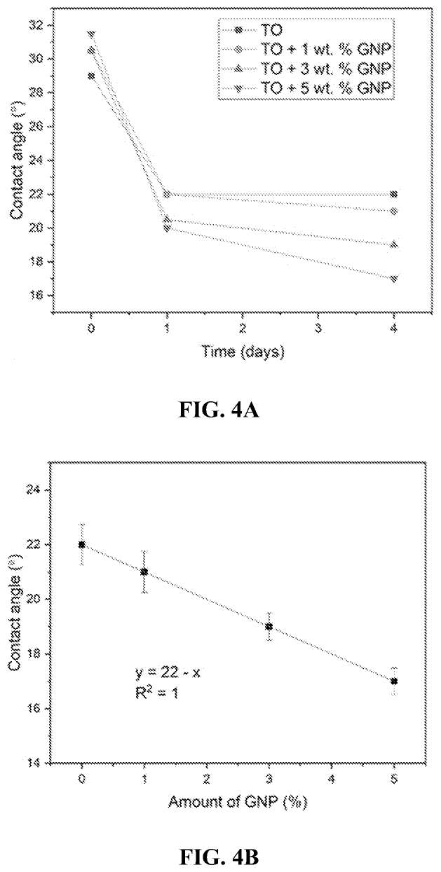

FIG. 4A and FIG. 4B are graphs showing the relationship between contact angle of a solution of the drying oil and graphene nanoplatelets and the content of graphene nanoplatelets. Contact angle measurements are a way to investigate the cohesive and adhesive forces of a particular solution. The contact angle measurements shown in FIG. 4A and FIG. 4B were performed on tung oil (TO) with different percentages of graphene nanoplatelets (GNP) on a glass slide over a time of 4 days. FIG. 4A shows that at zero days, the value of the contact angle increased with the addition of GNP, but after day 1 the trend reversed. As shown, the sample with 5 wt. % GNP had the highest contact angle value while neat TO without GNP and TO+1 wt. % GNP had same values. On day 4, the differences were much more emphasized showing that TO without GNP has the highest contact angle which decreased with further addition of GNP. FIG. 4B shows contact angle values as related to the amount of GNP used. Linear fit showed perfect correlation with R 2=1. Without wishing to be bound by theory, the reason for the reduction of contact angle in the first stage (day 1) can be associated with the shrinkage due to the polymerization/drying of TO. For samples with GNP, there was another phenomenon associated to the precipitation of GNP on the contact surface with the glass slide, thus the adhesion with the glass was improved and the contact angle was reduced. Higher times (day 4 and beyond) enabled enough time to have appropriate precipitation and clear difference between the samples.

### Example 2

In this study, polymer-graphene nanomaterials were subjected to gel permeation chromatography (GPC) and transmission electron microscopy (TEM). GPC was used to determine the molecular characteristics of the sample components, including its molecular weight and polydispersity. TEM is known to be one of the most popular techniques in characterizing nanomaterials, as it can provide chemical and morphological information at a spatial resolution unparalleled by other techniques.

Gel Permeation Chromatography (GPC)

GPC is a technique employed to separate complex mixtures of macromolecules according to their hydrodynamic size. The technique involves a mobile phase and a stationary phase formed of porous particles. During separation, macromolecules with a high degree of polymerization (having large hydrodynamic size) are eluted from the column at earlier retention times, while smaller macromolecules with a lower degree of polymerization are retained in the porous particles and elute at later retention times. After undergoing separation through the GPC columns, the separated polymer fractions flow through a series of detectors including refractive index (RI), UV, light scattering (LS), and a viscometer.

A refractive index (RI) detector is employed to calculate concentration, refractive index increment (dn/dc), and injection recovery of polymer solutions. A UV detector is employed to calculate the concentration of UV absorbing material and the UV extinction coefficient (dA/dc). Light scattering provides absolute molecular weight and radius of gyration, while the viscometer delivers intrinsic viscosity, hydrodynamic radius, and chain conformational and structural parameters (i.e., branching). For the purposes of this study, the RI and UV detectors were employed in the GPC instruments.

GPC analyses will provide absolute and relative average molecular weights of the polymer including number-average molecular weight (Mn), weight-average molecular weight (Mw), and z-average molecular weight (Mz). These averages describe the distribution of polymer chain lengths included in a sample. In conventional GPC analysis, the column is calibrated by analyzing a series of poly(methyl methacrylate) (PMMA) standards of varying molecular weights that cover the elution volume of the targeted polymer peak (typically 8-12 standards are sufficient). Based on the molecular weight of these PMMA standards, a calibration curve of log(molecular weight) as a function of retention volume is constructed upon which polymer molecular weights are calculated.

GPC-light scattering (GPC-LS) measurements are dependent on the optical properties of the polymer in the medium/mobile phase used in the analysis. As such, each polymer component will have a specific optical constant (K) which is dependent on the squared value of the refractive index increment (dn/dc)² of each polymer in each solvent. Measuring the absolute molecular weight of a polymer by GPC-LS requires an accurate do/dc for this material. The light scattering referred to is static or classical light scattering, also known as Rayleigh light scattering. A static light scattering detector comprises a sample cell, a laser beam, and one or more detectors to collect the scattered laser light. The detectors are set at an angle to the incident beam, which may vary depending on the design of the detector.

TABLE 2

| Sample No. | Sample Name/Batch No. | Physical Form | Purity |
|---|---|---|---|
| 1 | Pure TO MC | White cloudy liquid | N/A |
| 2 | 1% GNP | Black cloudy liquid | N/A |
| 3 | 3% GNP | Black cloudy liquid | N/A |
| 4 | 5% GNP | Black cloudy liquid | N/A |

| | |
|---|---|
| Filtration | Filtered with 0.22 μm PTFE syringe filter |
| GPC Filter Size | 0.22m PTFE post column filter |

Samples in TABLE 2 were prepared by freeze drying 2 mL of each sample overnight. The weights of the freeze-dried sample were recorded, and then 2 mL of THF was added. The samples were gently rocked at room temperature overnight to dissolve. The samples were diluted to a concentration of 30 mg/mL in THF. The samples were filtered through 0.22 μm PTFE syringe filters and then injected for GPC analysis. PFTE refers to Polytetrafluoroethylene.

TABLE 3

| | |
|---|---|
| Instrument | Viscotek TDA305 and GPCmax |
| Detectors | Refractive Index |
| Mobile Phase | THF |
| SEC/GPC Columns | TSKgel GMPWXL × 2 |
| Flow Rate | 1.0 mL/min |
| Analysis Temperature | 30° C. |
| Analysis Software | OmniSEC 4.6.2 |
| Calibration Type | Conventional Calibration Method |
| Calibration Standards | PS |
| Concentration of the Standards | 1.0-3.0 mg/mL |
| Refractive Index of Solvent | 1.405 |
| Injections per Sample | 3/sample |

TABLE 3 shows the method setup and parameters used for the GPC testing described within this example.

All individual injection GPC results were processed by setting baselines and limits for the polymer peak using the OmniSEC Software Version 4.6.2. Raw data, average results and acceptance criteria of polymer concentration, recovery, number-average molecular weight (Mn), weight-average molecular weight (Mw), Z-average (Mz) and polydispersity index (PDI=Mw/Mn) were calculated in Excel. Results are presented as averages and standard deviations and no comparative statistical analysis was performed.

Transmission Electron Microscopy (TEM)

After air-drying aliquots of the samples for several hours until they appeared to be visibly dry under a dissecting microscope, an epoxy resin was added to the sample vials and put the samples into a vacuum oven (10 in.Hg) for an hour to improve infiltration of the resin. Later, the samples were placed into embedding molds at 60° C. overnight. Thin sections (approximately 80 nm) were cut with a diamond knife on a Leica UCT ultramicrotome and picked up onto Cu grids. Sections were viewed in a JEOL JEM 1200 EX TEMSCAN transmission electron microscope (JEOL, Peabody, MA, USA) operating at an accelerating voltage of 80 kV. Images were acquired with an AMT 4-megapixel digital camera (Advanced Microscopy Techniques, Woburn, MA).

GPC Results

To prepare the samples for GPC analysis, 2 mL of each solution was freeze dried at room temperature overnight (at least 18 hours) to remove the solvent and isolate the polymer and other non-volatile components. The residues were weighed and dissolved in 2 mL of THF, then left on the rocker at room temperature overnight (at least 18 hours) to dissolve. During a preliminary attempt at GPC analysis the samples were subsequently diluted with THF to a concentration of 3 mg/mL and injected for GPC; however, there were no polymer peaks present when these samples were analyzed. Since the polymeric component of the samples was too dilute for analysis, a new batch of samples were re-prepared and diluted to 30 mg/mL in THF for GPC analysis.

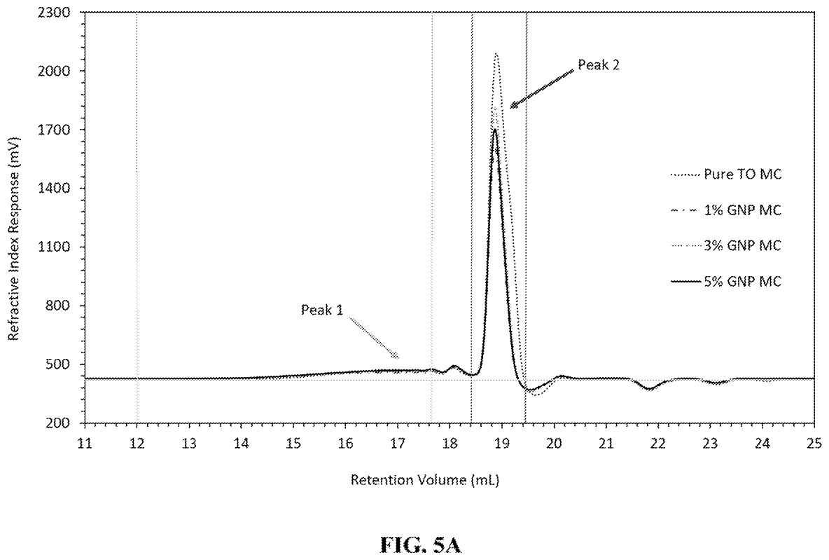

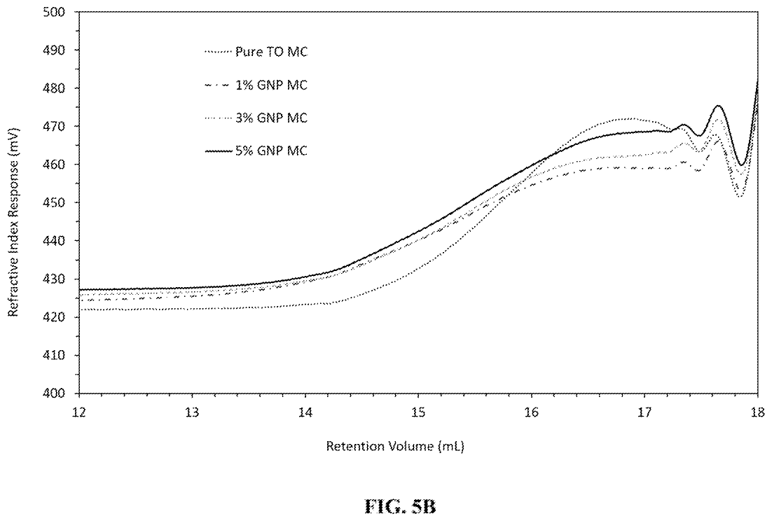

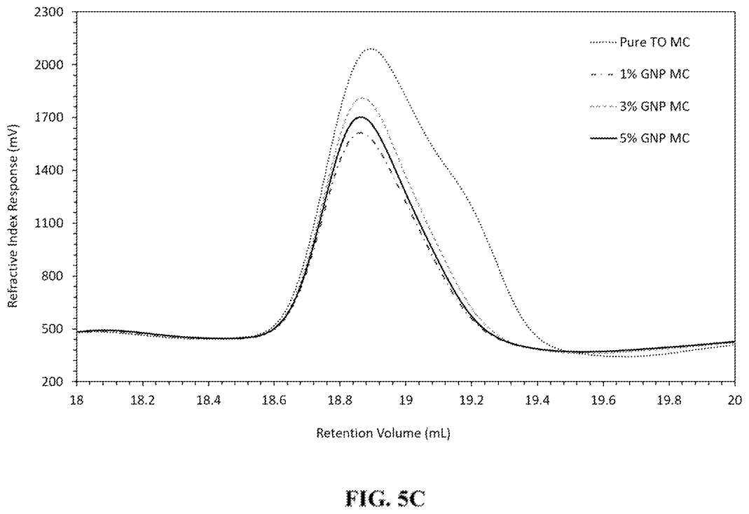

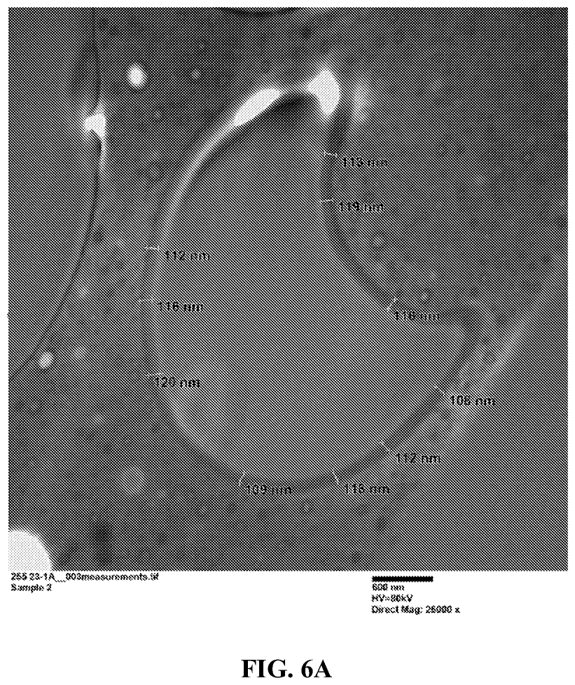

During GPC analysis, two peaks were observed in all of the sample chromatograms. FIG. 5A, FIG. 5B, and FIG. 5C are gel permeation chromatography/refractive index (GPC-RI) chromatograms for pure tung oil microcapsules, microcapsules containing 1% graphene nanoplatelets, microcapsules containing 3% graphene nanoplatelets, and microcapsules containing 5% graphene nanoplatelets. FIG. 5A shows the baseline full spectrum. FIG. 5B is a zoomed-in image of Peak 1 from FIG. 5A. FIG. 5C is a zoomed-in image of Peak 2 from FIG. 5A. The first peak (at lower retention time, i.e., higher molecular weight) had a Mw of 16,179 Da in the pure tung oil sample, 35,992 Da in the 1% GNP sample, 34,196 Da in the 3% GNP sample, and 24,929 Da in the 5% GNP sample.

The second, much larger, peak had a Mw of approximately 1,300 Da in each of the samples and an extremely narrow polydispersity, suggesting it belongs to a small-molecule (non-polymeric) component of the sample mixtures, without wishing to be bound by theory.

It is noted that the Mw and Mz increased with GNP content at 1% and 3% vs. the control sample, which can arise from aggregates present in the sample. Overlays of GPC-RI and GPC-LS from the first injection samples were plotted to identify the presence of aggregation. Comparing the GPC-RI chromatograms with the corresponding GPC-LS chromatograms confirm the presence of aggregates at 12 min retention time. Interestingly, the intensity of the GPC-LS peak was higher in GNP 1% and 3% compared to pure and 5% GNP samples which may explain the higher Mw and Mz values in samples containing 1 and 3% GNP.

During this GPC analysis, polymer peaks were observed, with the results summarized in TABLE 4.

TABLE 4

| | | | Vp | Mn | Mw | Mz | Mp | Mw/Mn |
|---|---|---|---|---|---|---|---|---|
| Sample ID | Peak # | Injection | (mL) | (Da) | (Da | (Da) | (Da) | (PDI) |
| Pure TO | 1 | 1 | 16.833 | 9,356 | 15,369 | 26,621 | 8,882 | 1.643 |
| MC | | 2 | 16.827 | 9,252 | 16,977 | 38,728 | 8,917 | 1.835 |
| | | 3 | 16.837 | 9,226 | 16,190 | 32,668 | 8,850 | 1.755 |
| | | Average | 16.832 | 9,278 | 16,179 | 32,672 | 8,883 | 1.744 |
| | | a (±) | 0.004 | 56 | 657 | 4,943 | 27 | 0.079 |
| | | % RSD | 0.02% | 0.61% | 4.06% | 15.13% | 0.31% | 4.51% |
| | 2 | 1 | 18.887 | 1,253 | 1,283 | 1,314 | 1,348 | 1.024 |
| | | 2 | 18.887 | 1,255 | 1,285 | 1,316 | 1,346 | 1.025 |
| | | 3 | 18.893 | 1,242 | 1,272 | 1,303 | 1,336 | 1.025 |
| | | Average | 18.889 | 1,250 | 1,280 | 1,311 | 1,343 | 1.025 |
| | | a (±) | 0.003 | 6 | 6 | 6 | 5 | 0.000 |
| | | % RSD | 0.01% | 0.46% | 0.45% | 0.44% | 0.39% | 0.05% |
| 1% GNP | 1 | 1 | 17.617 | 10,854 | 32,470 | 147,118 | 4,340 | 2.992 |
| | | 2 | 17.633 | 10,676 | 37,560 | 213,848 | 4,262 | 3.518 |
| | | 3 | 17.643 | 10,680 | 37,945 | 226,803 | 4,223 | 3.553 |
| | | Average | 17.631 | 10,737 | 35,992 | 195,923 | 4,275 | 3.354 |
| | | a (±) | 0.011 | 83 | 2,495 | 34,913 | 49 | 0.257 |
| | | % RSD | 0.06% | 0.77% | 6.93% | 17.82% | 1.14% | 7.65% |
| | 2 | 1 | 18.847 | 1,344 | 1,366 | 1,388 | 1,399 | 1.016 |
| | | 2 | 18.86 | 1,333 | 1,354 | 1,376 | 1,382 | 1.016 |
| | | 3 | 18.863 | 1,323 | 1,344 | 1,365 | 1,376 | 1.016 |
| | | Average | 18.857 | 1,333 | 1,355 | 1,376 | 1,386 | 1.016 |
| | | a (±) | 0.007 | 9 | 9 | 9 | 10 | 0.000 |
| | | % RSD | 0.04% | 0.64% | 0.66% | 0.68% | 0.70% | 0.00% |
| 3% GNP | 1 | 1 | 17.62 | 10,616 | 34,305 | 226,688 | 4,312 | 3.231 |
| | | 2 | 17.63 | 10,485 | 32,937 | 207,783 | 4,285 | 3.141 |
| | | 3 | 17.643 | 10,090 | 35,345 | 242,144 | 4,233 | 3.503 |
| | | Average | 17.631 | 10,397 | 34,196 | 225,538 | 4,277 | 3.292 |
| | | a (±) | 0.009 | 224 | 986 | 14,051 | 33 | 0.154 |
| | | % RSD | 0.05% | 2.15% | 2.88% | 6.23% | 0.77% | 4.68% |
| | 2 | 1 | 18.853 | 1,320 | 1,343 | 1,366 | 1,386 | 1.018 |
| | | 2 | 18.863 | 1,317 | 1,341 | 1,364 | 1,377 | 1.017 |
| | | 3 | 18.867 | 1,323 | 1,338 | 1,360 | 1,371 | 1.016 |
| | | Average | 18.861 | 1,320 | 1,341 | 1,363 | 1,378 | 1.017 |
| | | a (±) | 0.006 | 2 | 2 | 2 | 6 | 0.001 |
| | | % RSD | 0.03% | 0.19% | 0.15% | 0.18% | 0.45% | 0.08% |
| 5% GNP | 1 | 1 | 17.627 | 10,054 | 24,726 | 108,476 | 4,301 | 2.459 |
| | | 2 | 17.633 | 9,966 | 22,907 | 71,228 | 4,262 | 2.298 |
| | | 3 | 17.643 | 9,877 | 27,154 | 149,950 | 4,223 | 2.749 |
| | | Average | 17.634 | 9,966 | 24,929 | 109,885 | 4,262 | 2.502 |
| | | a (±) | 0.007 | 72 | 1,740 | 32,154 | 32 | 0.187 |
| | | % RSD | 0.04% | 0.73% | 6.98% | 29.26% | 0.75% | 7.46% |
| | 2 | 1 | 18.857 | 1,328 | 1,350 | 1,371 | 1,386 | 1.017 |
| | | 2 | 18.863 | 1,317 | 1,339 | 1,361 | 1,376 | 1.017 |
| | | 3 | 18.863 | 1,323 | 1,344 | 1,365 | 1,378 | 1.016 |
| | | Average | 18.861 | 1,323 | 1,344 | 1,366 | 1,380 | 1.017 |
| | | a (±) | 0.003 | 4 | 4 | 4 | 4 | 0.000 |
| | | % RSD | 0.01% | 0.34% | 0.33% | 0.30% | 0.31% | 0.05% |

TEM Results

Polymer-graphene nanomaterials were prepared as described above for TEM. The use of resin may provide structural stability to improve the TEM images, without wishing to be bound by theory. TEM images gathered at various magnifications for pure tung oil (TO) microcapsules, and microcapsules containing 1%, 3%, and 5% GNP. The TEM analysis disclosed herein demonstrates that the graphene nanoplatelets were contained within the core of the microcapsules at all graphene loadings, rather than in the wall of the microcapsules, which has not been previously achieved before the present work. It is contemplated that the shape of the microcapsules may be influenced by the preparation method used for TEM analysis, without wishing to be bound by theory.

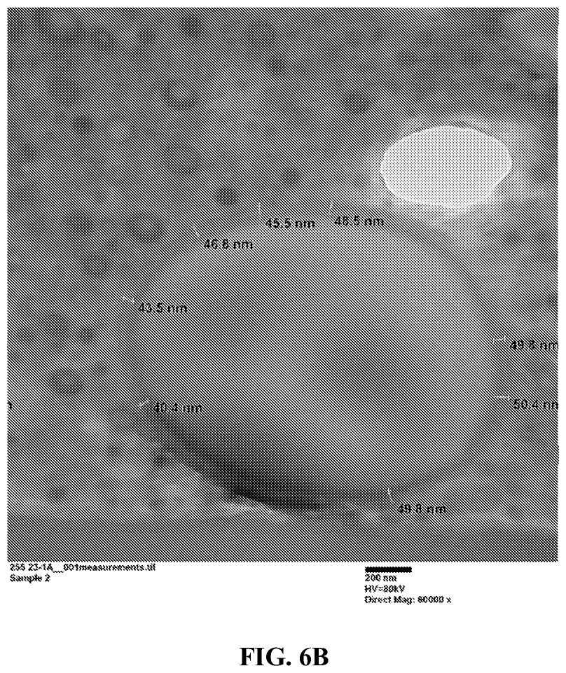

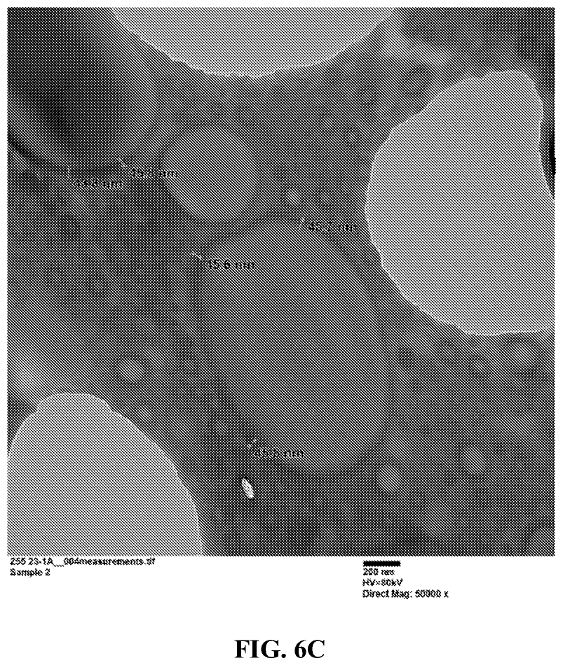

FIG. 6A is a TEM image of pure tung oil microcapsules at 25,000× magnification, scale bar 600 nm. FIG. 6B is a TEM image of pure tung oil microcapsules at 60,000× magnification, scale bar 200 nm. FIG. 6C is a TEM image of pure tung oil microcapsules at 50,000× magnification, scale bar 200 nm. The TEM image of pure TO MC sample reveals spheres with a brighter core and a darker corona. In general, the darker areas in TEM represent areas of the sample where fewer electrons are transmitted through while the brighter areas of the TEM image correspond to those areas of the sample that more electrons were transmitted through. The thickness of the darker corona was measured to be in the range of 45-114 nm.

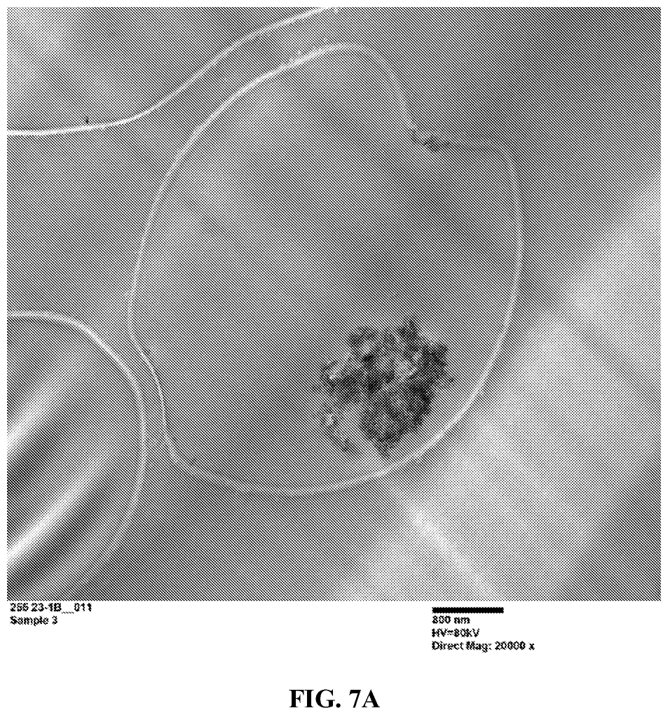

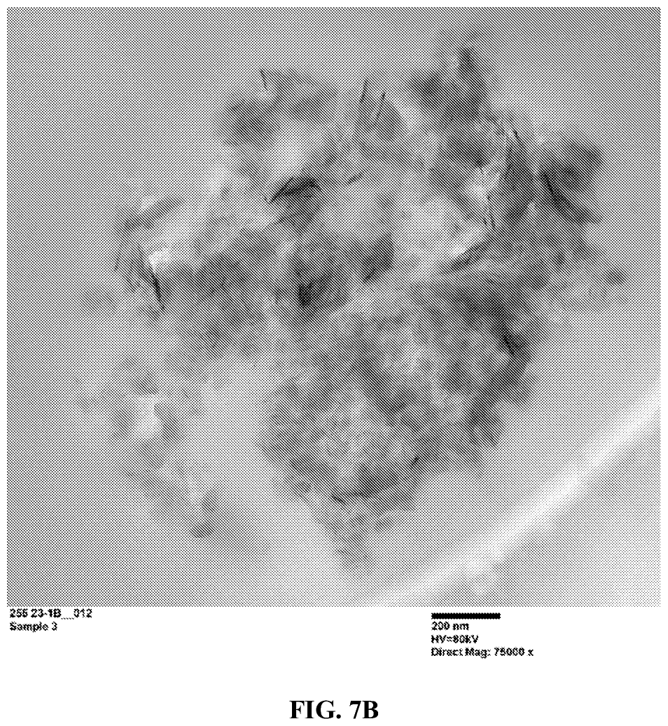

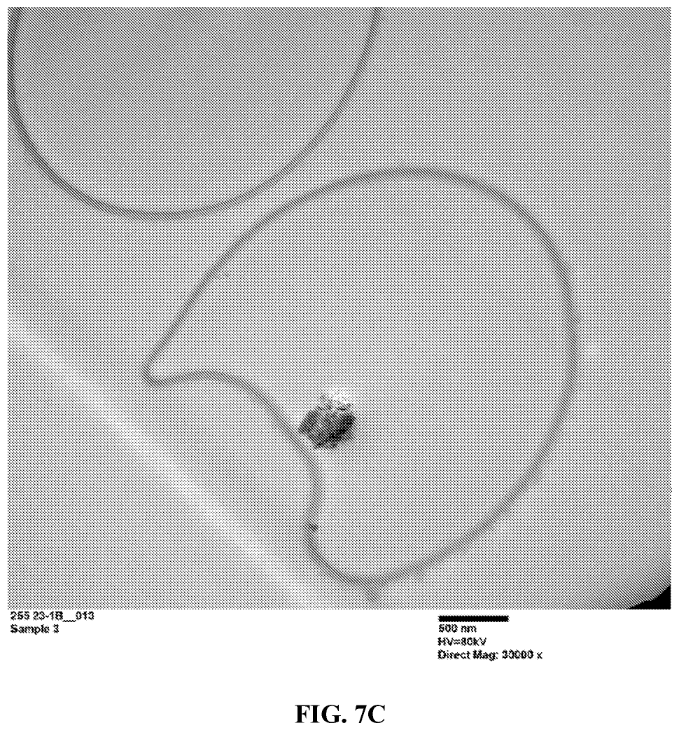

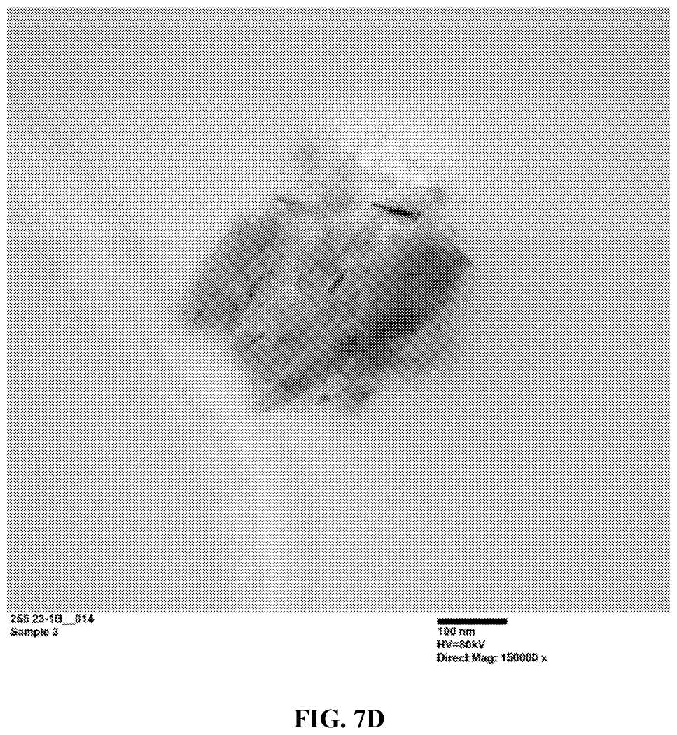

The TEM images of samples under different magnification, containing 1% to 5% GNP, showed dark particles that seem to correspond to graphene. FIG. 7A is a TEM image of microcapsules containing 1% graphene nanoplatelets at 20,000× magnification, scale bar 200 nm. FIG. 7B is a TEM image of microcapsules containing 1% graphene nanoplatelets at 75,000× magnification, scale bar 200 nm. FIG. 7C is a TEM image of microcapsules containing 1% graphene nanoplatelets at 30,000× magnification, scale bar 500 nm. FIG. 7D is a TEM image of microcapsules containing 1% graphene nanoplatelets at 150,000× magnification, scale bar 100 nm.

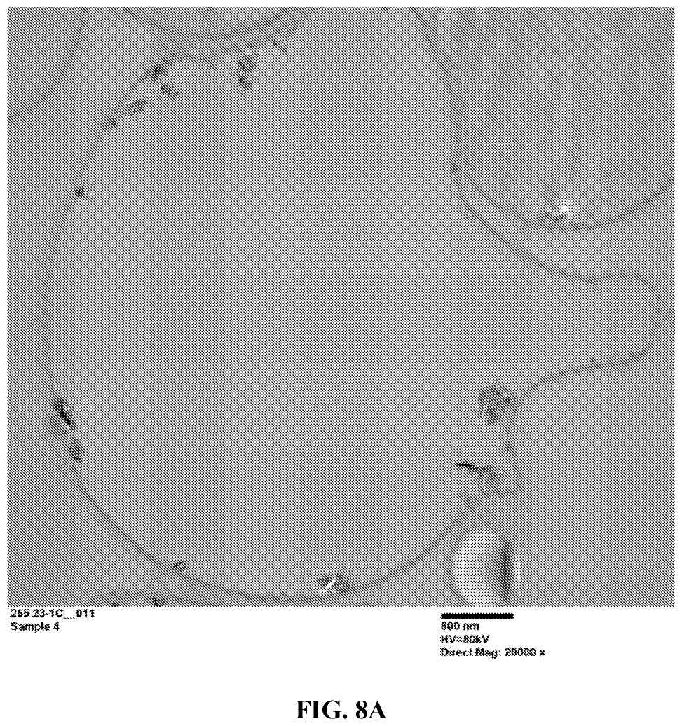

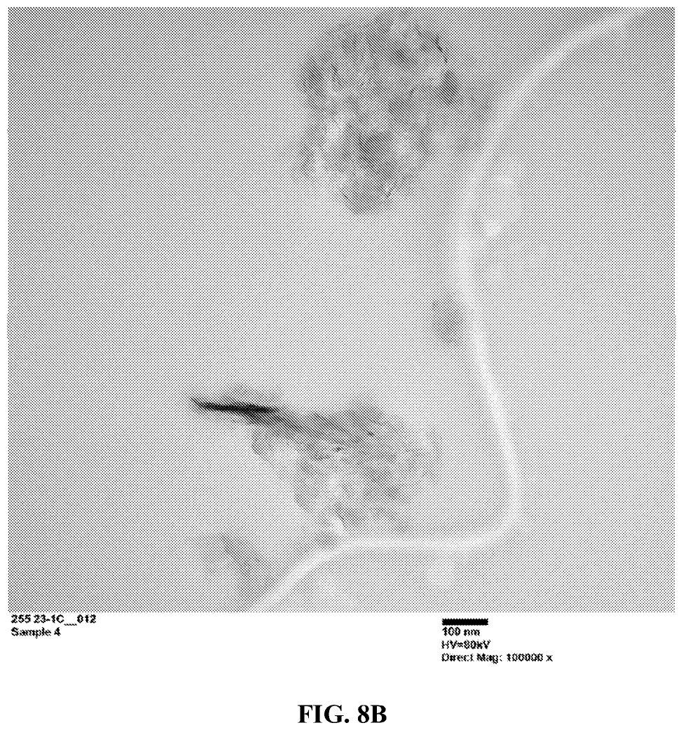

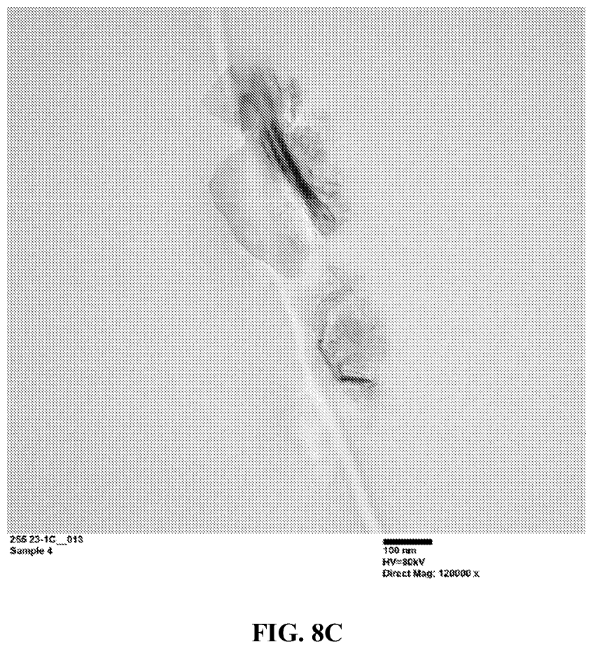

FIG. 8A is a TEM image of microcapsules containing 3% graphene nanoplatelets at 20,000× magnification, scale bar 800 nm. FIG. 8B is a TEM image of microcapsules containing 3% graphene nanoplatelets at 100,000× magnification, scale bar 100 nm. FIG. 8C is a TEM image of microcapsules containing 3% graphene nanoplatelets at 120,000× magnification, scale bar 100 nm.

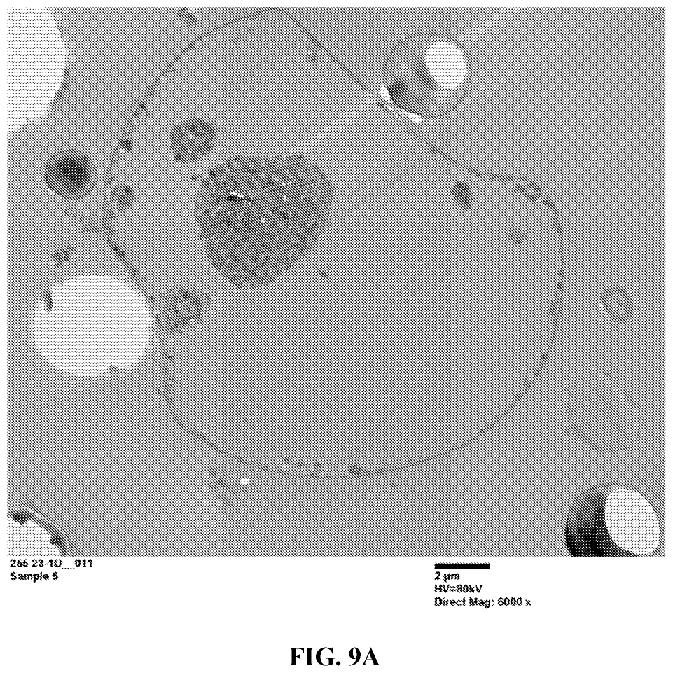

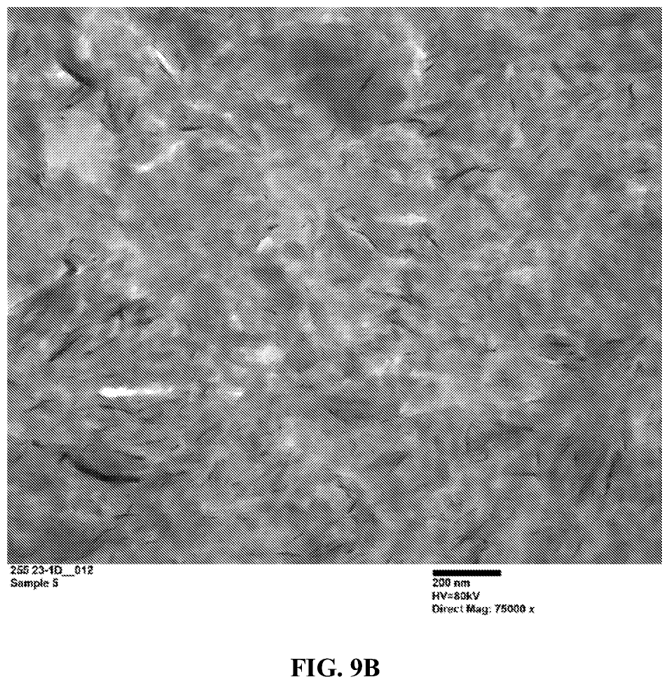

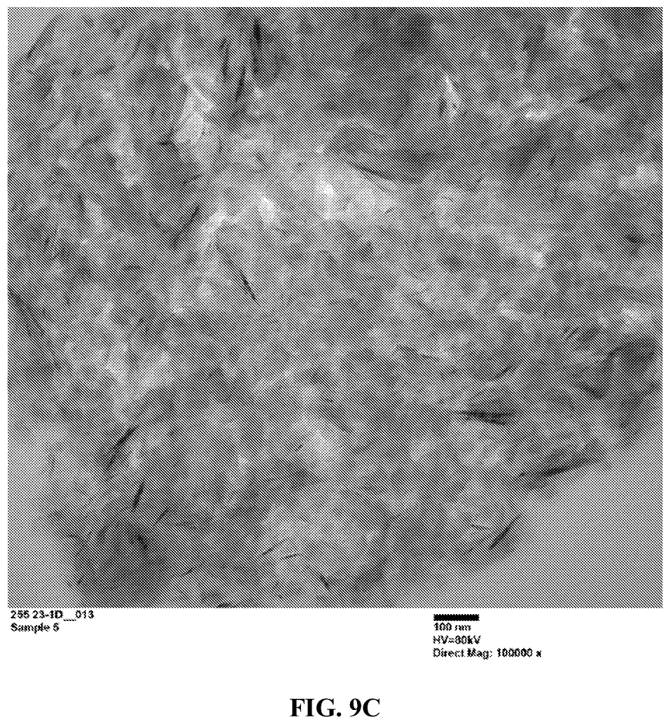

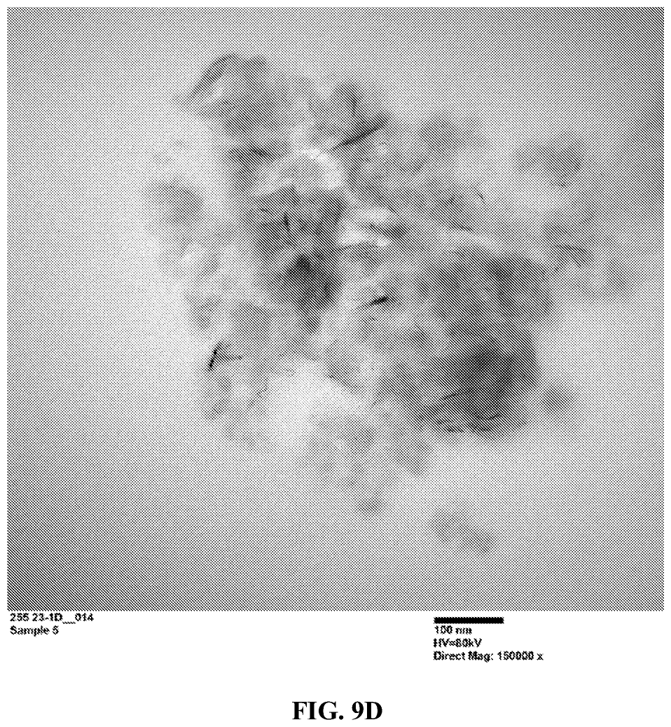

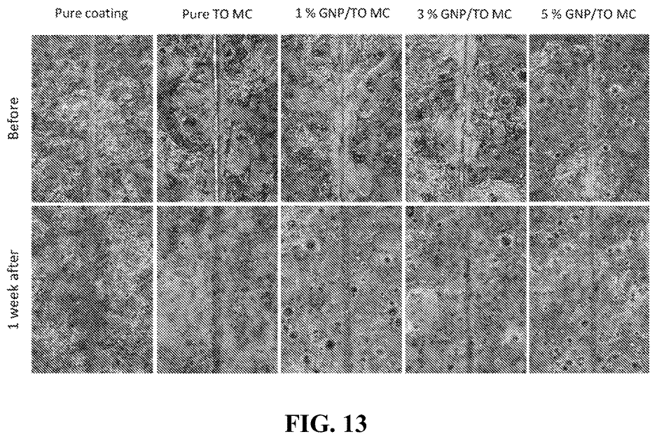

FIG. 9A is a TEM image of microcapsules containing 5% graphene nanoplatelets at 6,000× magnification, scale bar 2 μm. FIG. 9B is a TEM image of microcapsules containing 5% graphene nanoplatelets at 75,000× magnification, scale bar 200 nm. FIG. 9C is a TEM image of microcapsules containing 5% graphene nanoplatelets at 100,000× magnification, scale bar 100 nm. FIG. 13D is a TEM image of microcapsules containing 5% graphene nanoplatelets at 150,000× magnification, scale bar 100 nm.

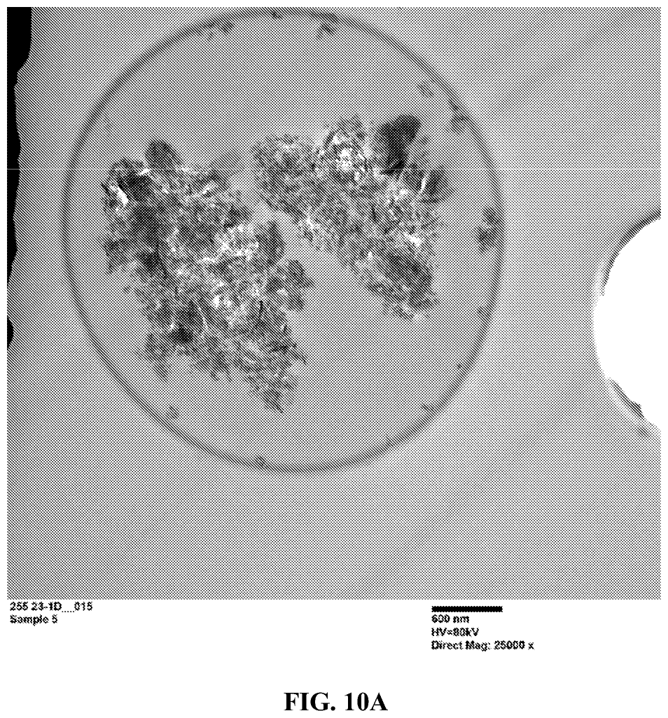

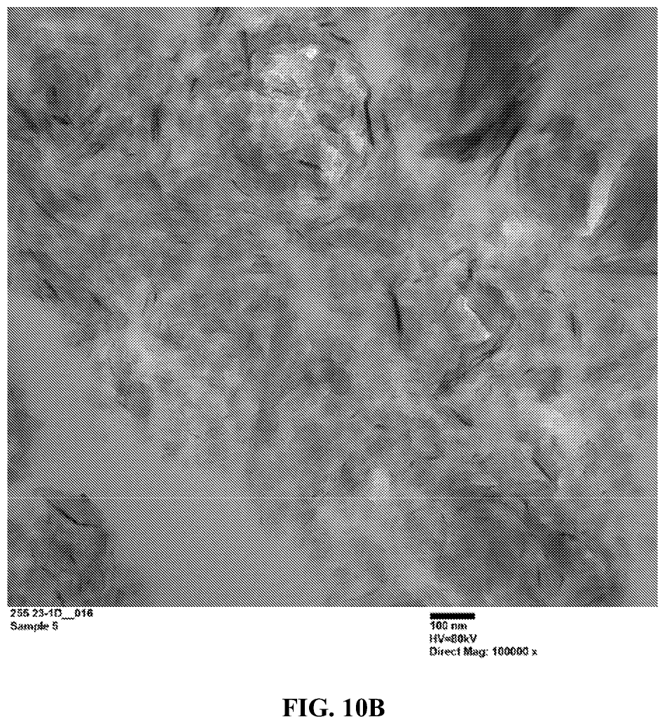

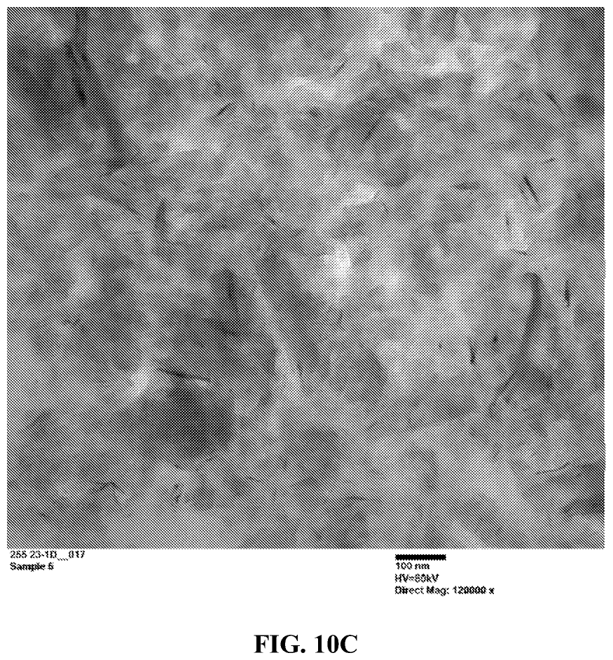

FIG. 10A is a TEM image of microcapsules containing 5% graphene nanoplatelets at 25,000× magnification, scale bar 600 nm. FIG. 10B is a TEM image of microcapsules containing 5% graphene nanoplatelets at 100,000× magnification, scale bar 100 nm. FIG. 10C is a TEM image of microcapsules containing 5% graphene nanoplatelets at 120,000× magnification, scale bar 100 nm.

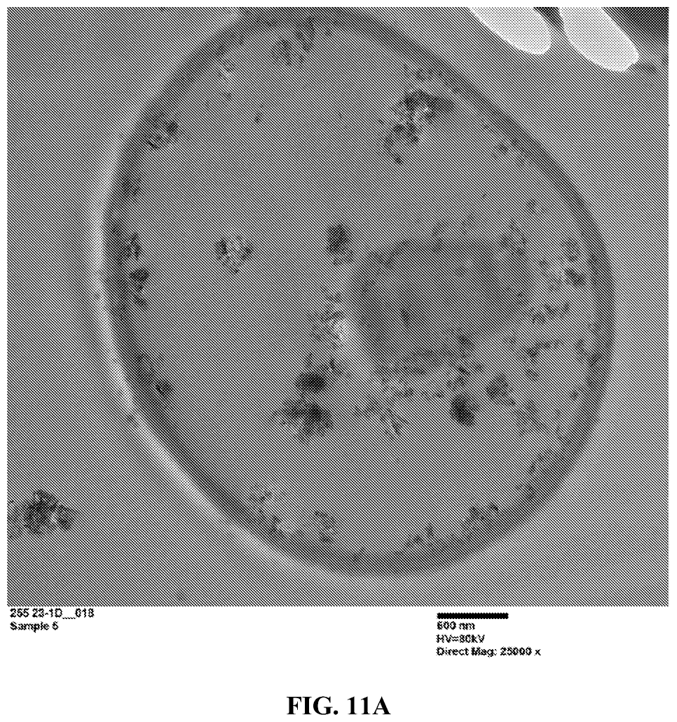

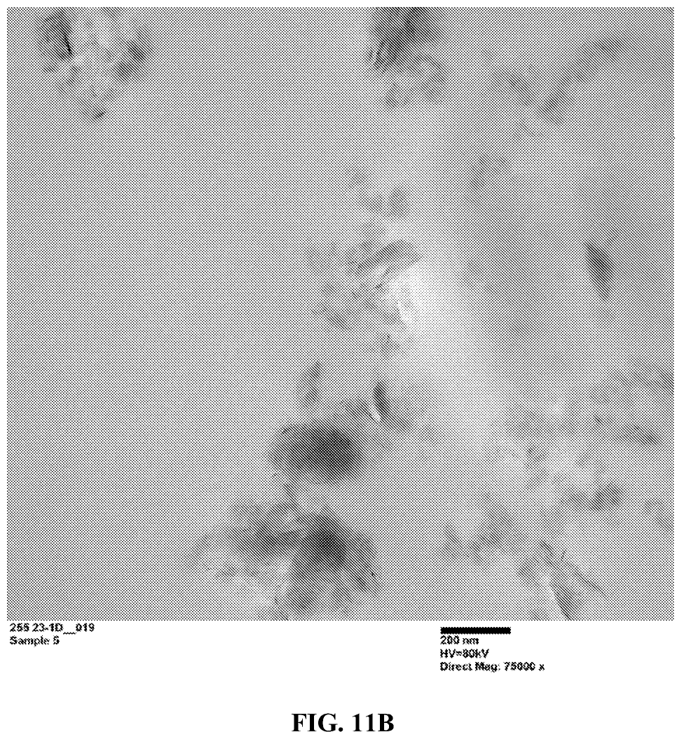

FIG. 11A is a TEM image of microcapsules containing 5% graphene nanoplatelets at 25,000× magnification, scale bar 600 nm. FIG. 11B is a TEM image of microcapsules containing 5% graphene nanoplatelets at 75,000× magnification, scale bar 200 nm.

GPC and TEM analysis were performed on a series of polymer/graphene-containing samples, with varying graphene content ranging from 0-5%. The liquid samples were freeze-dried prior to GPC analysis and then re-dissolved in THF. When analyzed at a “total solids” concentration of 30 mg/mL, the samples were each found to contain two peaks in their GPC chromatograms. The first peak at lower retention volume (i.e., higher molecular weight) had a Mw in the range of 15-35 kDa, whereas the second (much larger) peak had a low molecular weight and narrow polydispersity, indicative of it belonging to a non-polymeric component within the sample mixture. GPC-LS chromatograms of the samples confirmed the presence of aggregates where samples containing 1 and 3% GNP had the highest amount of aggregates resulting in higher Mw and Mz values.

TEM images gathered from samples containing different amount of graphene nanoplatelets revealed dark particles indicative of graphene. TEM images gathered from pure TO MC sample reveal spheres with a brighter core and a darker corona where the thickness of the corona is in the range of 45 nm to 114 nm.

### Example 3

The mechanical properties of microcapsules were measured using a micromanipulation technique based on the parallel plate compression of individual microparticles using a force transducer (Model 403A, Aurora Scientific Inc, Canada). A droplet of microcapsule suspension was pipetted onto a specially designed highly tempered glass slide, which was left drying in air for at least 1 hr at ambient temperature of 23.5±1.5° C. before single microcapsules were tested. A compression speed of 2.0 μm·s⁻¹ was selected, and used to compress each single microcapsule. The diameter of each microcapsule was measured using a side-view camera (AM4023CT, DinoEye C-Mount Camera, Dino-Lite, Hemel Hempstead, UK). Fifty single randomly selected microcapsules were compressed in order to generate statistically representative results.

The data of force versus displacement generated from the micromanipulation measurements were analyzed to determine the rupture force (Fᵣ), displacement at rupture δᵣ), which combined with the diameter (D) were used to calculate the fractional deformation (∈ᵣ), nominal rupture tension (Tᵣ), nominal rupture stress (σᵣ) and apparent toughness (T_{c}). Moreover, the force versus displacement data up to a fraction deformation (ratio of the displacement to its original diameter) of 10% were used to calculate the apparent Young's modulus E value of single microcapsules based on the Hertz model and an assumption of incompressible microcapsule (Poisson ratio equal to 0.5) and Coefficient of Determination (R₂). The results of the micromanipulation measurements are summarized in TABLE 5.

The pure tung oil microcapsules exhibited an apparent toughness of 0.52 MPa, and a Young/s modulus of 28 MPa. However, when 1% GNP was added to the microcapsules, the value of the toughness increased greatly to 0.89 MPa, which was a 71% increase, and the Young's modulus went to 39 MPa, also increasing compared to the pure tung oil sample. The 3% GNP sample had an apparent toughness of 0.82 MPa with a Young's modulus of 40 MPa, while the 5% GNP sample had a toughness of 0.89 MPa and a Young's modulus of 38 MPa. Overall, the GNP-containing samples all conveyed a large increase in the mechanical strength of the pure tung oil microcapsules, which indicates a benefit for long term storage and handling of the microcapsules and long-term containment of the core material.

TABLE 5

| | | | | Fractional | Nominal | | | |
|---|---|---|---|---|---|---|---|---|
| | | | | deformation | rupture stress | | | Apparent |
| | | Displacement | Rupture | at rupture | σr | Nominal | Apparent | Young's |
| | Diameter | at rupture | force (Fᵣ), | (%) | (=Fᵣ/(π/4*D²), | rupture | toughness | modulus |
| Sample | (D), μm | (δᵣ), μm | mN | (δᵣ/D × 100) | MPa | tension | (T_{c}), MPa | (E), MPa |
| Pure | 9.7 ± 0.8 | 3.0 ± 0.7 | 0.25 ± 0.10 | 32.7 ± 9.9 | 4.27 ± 2.02 | 28.2 ± 6.2 | 0.52 ± 0.30 | 28 ± 4 |
| MC | | | | | | | | |
| 1% | 15.2 ± 1.0 | 7.6 ± 0.5 | 0.76 ± 0.06 | 55.2 ± 2.8 | 6.88 ± 0.76 | 61.0 ± 5.3 | 0.89 ± 0.10 | 39 ± 3 |
| GNP | | | | | | | | |
| 3% | 12.9 ± 0.7 | 6.6 ± 0.4 | 0.63 ± 0.04 | 52.5 ± 1.7 | 6.16 ± 0.58 | 52.4 ± 3.6 | 0.82 ± 0.07 | 40 ± 2 |
| GNP | | | | | | | | |
| 5% | 11.2 ± 0.4 | 6.3 ± 0.2 | 0.66 ± 0.04 | 56.8 ± 1.4 | 7.76 ± 0.61 | 62.2 ± 4.2 | 0.89 ± 0.06 | 38 ± 3 |
| GNP | | | | | | | | |

### Example 4

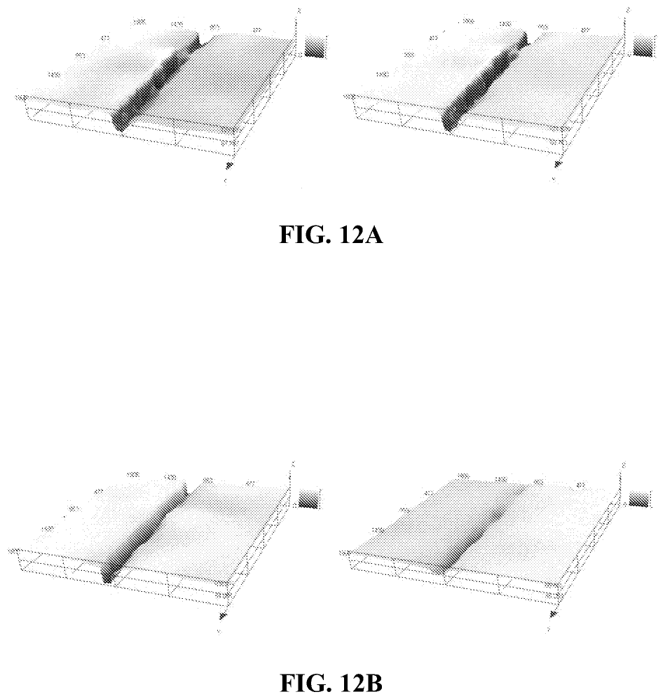

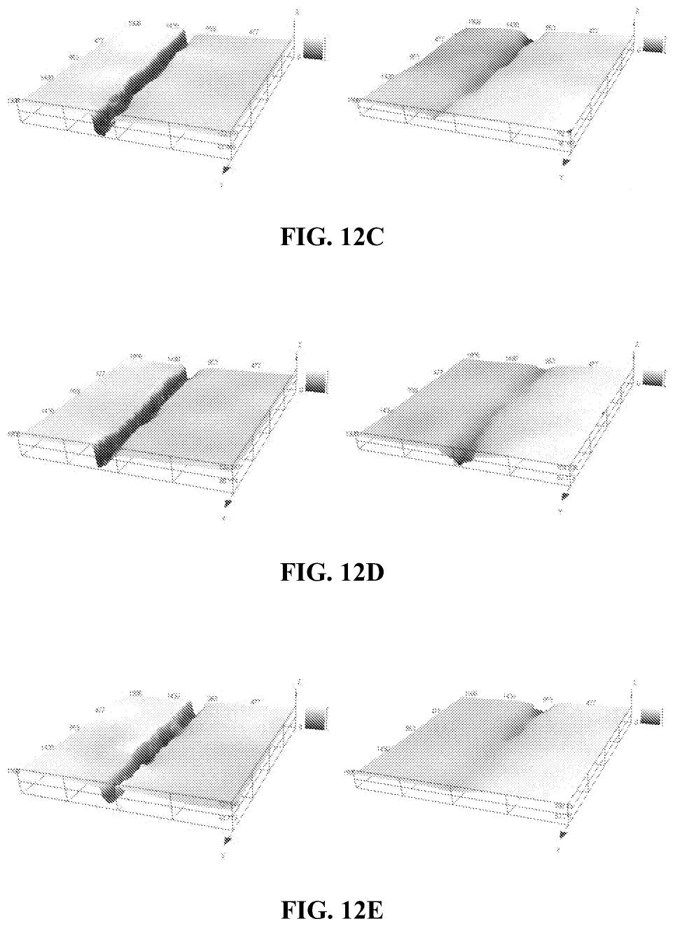

The healing capacity of the microcapsules of the present disclosure was evaluated. FIGS. 12A-12E are optical microscopy images of steel substrates which were scratched with a scalpel. An epoxy coating was applied to evaluate healing capacity. FIG. 12A shows a coating of pure epoxy, FIG. 12B shows an epoxy coating with pure tung oil microcapsules, FIG. 12C shows an epoxy coating with microcapsules containing 1% graphene nanoplatelets, FIG. 12D shows an epoxy coating with microcapsules containing 3% graphene nanoplatelets, and FIG. 12E shows an epoxy coating with microcapsules containing 5% graphene nanoplatelets.

The optical microscopy images were used to observe the scratch depth before and after the healing process. The coating without microcapsules (pure epoxy) did not exhibit clear healing, with a healing efficiency of 3%, while the coating which included pure tung oil microcapsules exhibit a healing efficiency of 92%. The addition of GNP microcapsules further increased the healing efficiency, with 93%, 94%, and 95% healing efficiency observed for coating which included microcapsules having 1%, 3%, and 5% GNP, respectively. The addition of GNP has the added benefit of a long-term increase in the mechanical properties of the microcapsules.

FIG. 13 is an image of steel substrates which were scratched with a scalpel followed by application of an epoxy coating. The epoxy coatings were, from left to right, pure epoxy, epoxy coating with pure tung oil microcapsules, epoxy coating with microcapsules containing 1% graphene nanoplatelets, epoxy coating with microcapsules containing 3% graphene nanoplatelets, and epoxy coating with microcapsules containing 5% graphene nanoplatelets, showing the healing capabilities of each coating.

The scratched substrates with the coatings as described above where immersed in 3.5 wt. % NaCl solution and kept there for a duration of one week. As shown in FIG. 13, the substrate with the pure epoxy coating exhibited significant corrosion due to lack from protection from the salt solution. However, the coatings which included pure tung oil microcapsules and GNP-containing microcapsules exhibits little to no corrosion after one week, demonstrating that coatings containing microcapsules provided excellent protection from the salt solution.

In the above detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be used, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions or biological systems, which can, of course, vary. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (for example, bodies of the appended claims) are generally intended as “open” terms (for example, the term “including” should be interpreted as “including but not limited to,” the term “having” should be interpreted as “having at least,” the term “includes” should be interpreted as “includes but is not limited to,” et cetera). While various compositions, methods, and devices are described in terms of “comprising” various components or steps (interpreted as meaning “including, but not limited to”), the compositions, methods, and devices can also “consist essentially of” or “consist of” the various components and steps, and such terminology should be interpreted as defining essentially closed-member groups. It will be further understood by those within the art that if a specific number of an introduced claim recitation is intended, such an intent will be explicitly recited in the claim, and in the absence of such recitation no such intent is present.

For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (for example, “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (for example, the bare recitation of “two recitations,” without other modifiers, means at least two recitations, or two or more recitations). Furthermore, in those instances where a convention analogous to “at least one of A, B, and C, et cetera” is used, in general such a construction is intended in the sense one having skill in the art would understand the convention (for example, “a system having at least one of A, B, and C” would include but not be limited to systems that have A alone, B alone, C alone, A and B together, A and C together, B and C together, and/or A, B, and C together, et cetera). In those instances where a convention analogous to “at least one of A, B, or C, et cetera” is used, in general such a construction is intended in the sense one having skill in the art would understand the convention (for example, “a system having at least one of A, B, or C” would include but not be limited to systems that have A alone, B alone, C alone, A and B together, A and C together, B and C together, and/or A, B, and C together, et cetera). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, et cetera. As a non-limiting example, each range discussed herein can be readily broken down into a lower third, middle third and upper third, et cetera. As will also be understood by one skilled in the art all language such as “up to,” “at least,” and the like include the number recited and refer to ranges that can be subsequently broken down into subranges as discussed above. Finally, as will be understood by one skilled in the art, a range includes each individual member. Thus, for example, a group having 1-3 compounds refers to groups having 1, 2, or 3 compounds. Similarly, a group having 1-5 cells refers to groups having 1, 2, 3, 4, or 5 compounds, and so forth.

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. Nothing in this disclosure is to be construed as an admission that the embodiments described in this disclosure are not entitled to antedate such disclosure by virtue of prior invention. As used in this document, the term “comprising” means “including, but not limited to.”

As used herein, the term “about” means plus or minus 10% of the numerical value of the number with which it is being used. For example, “about 50%” means in the range of 45-55% and also includes exactly 50%.

Various of the above-disclosed and other features and functions, or alternatives thereof, may be combined into many other different systems or applications. Various presently unforeseen or unanticipated alternatives, modifications, variations, or improvements therein may be subsequently made by those skilled in the art, each of which is also intended to be encompassed by the disclosed embodiments.

What is claimed is:

1. A method for preparing microcapsules, comprising steps of:
providing a graphene-containing precursor,
combining the graphene-containing precursor with a drying oil such that the drying oil is intercalated within the graphene-containing precursor to form a graphene-containing aggregate;
adding the graphene-containing aggregate to an aqueous solution comprising an emulsifier, and
adding an encapsulating agent to form graphene-containing microcapsules.

2. The method of claim 1, wherein the graphene-containing precursor comprises graphene nanoplatelets.

3. The method of claim 1, wherein the drying oil comprises tung oil, linseed oil, perilla oil, walnut oil, or combinations thereof.

4. The method of claim 1, wherein combining the graphene-containing precursor with the drying oil comprises ultrasonic processing.

5. The method of claim 1, wherein the aqueous solution comprises 0.1 wt. % to 5 wt. % of the emulsifier.

6. The method of claim 1, wherein the aqueous solution further comprises at least one of 0.5 wt. % to 3.0 wt. % urea or melamine, 0.05 wt. % to 0.5 wt. % resorcinol, and 0.05 wt. % to 0.5 wt. % ammonium chloride.

7. The method of claim 1, wherein the emulsifier comprises gelatin, tween 80, poly(ethylene-alt-maleic anhydride), or combinations thereof.

8. The method of claim 1, wherein the encapsulating agent comprises formaldehyde.

9. The method of claim 1, wherein 1 wt. % to 5 wt. % of the encapsulating agent is added.

10. Core-shell microcapsules, comprising:
a graphene-containing precursor, and
a drying oil encapsulated within a shell material.

11. The core-shell microcapsules of claim 10, wherein the graphene-containing precursor comprises graphene nanoplatelets.

12. The core-shell microcapsules of claim 10, wherein the drying oil comprises tung oil, linseed oil, perilla oil, walnut oil, or combinations thereof.

13. The core-shell microcapsules of claim 10, wherein the drying oil is intercalated into the graphene-containing precursor.

14. The core-shell microcapsules of claim 10, wherein the shell material comprises urea-formaldehyde, melamine-formaldehyde, or combinations thereof.

15. The core-shell microcapsules of claim 10, wherein the shell material has a thickness of 280 nm to 360 nm.

16. The core-shell microcapsules of claim 10, wherein the core-shell microcapsules have a mean diameter of 0.5 μm to 25 μm.

17. The core-shell microcapsules of claim 10, wherein the core-shell microcapsules have an average surface roughness of 120 nm to 130 nm as measured by atomic force microscopy (AFM).

18. A self-healing material, comprising the core-shell microcapsules of claim 10.

19. The self-healing material of claim 18, wherein the self-healing material has a healing capability greater than a self-healing material which does not comprise a graphene-containing precursor.

20. A corrosion-resistant material, comprising the core-shell microcapsules of claim 10.
